(19) United States
(12) Patent Application Publication
(10) Pub. No.: US 2018/0022876 A1
(43) Pub. Date: Jan. 25, 2018

(54) ORGANOPOLYSILOXANE, RUBBER COMPOUNDING AGENT, RUBBER COMPOSITION, AND TIRE

(71) Applicant: SHIN-ETSU CHEMICAL CO., LTD., Tokyo (JP)

(72) Inventors: Munenao HIROKAMI, Annaka-shi, Gunma (JP); Kazuhiro TSUCHIDA, Annaka-shi, Gunma (JP)

(73) Assignee: SHIN-ETSU CHEMICAL CO., LTD., Tokyo (JP)

(21) Appl. No.: 15/546,242

(22) PCT Filed: Oct. 22, 2015
(86) PCT No.: PCT/JP2015/079788

§ 371 Date: Jul. 25, 2017

(30) Foreign Application Priority Data
Jan. 26, 2015 (JP) 2015-012317

(51) Int. Cl. C08G 77/48; C08L 9/06; C07F 7/18

(52) U.S. Cl. CPC C08G 77/48; C07F 7/1804; C08L 9/06; C08L 2205/06

(57) ABSTRACT

Provided are: an organopolysiloxane capable of achieving intended low fuel consumption properties and significantly reducing hysteresis loss in the cured product of a rubber composition during tire production; a rubber compounding agent comprising said organopolysiloxane; a rubber composition obtained by blending said rubber compounding agent; and a tire formed using said rubber composition. The organopolysiloxane, which is represented by average compositional formula (1), is characterized in: containing an organic group with a sulfide group; and the sulfide equivalents being 1,000 g/mol or less.

(A)ₐ(B)_{b}(C)c(R¹)_{d}SiO_{(4-2a-b-c-d)/2} (1)

(In the formula, A is a sulfide group-containing divalent organic group, B is a C5 to C10 monovalent hydrocarbon group, C is a hydrolyzable group and/or a hydroxyl group, R¹ is a C1 to C4 monovalent hydrocarbon group, and for a, b, c and d, 0<2a<1, 0<b<1, 0<c<3, 0≦d<2, and 0<2a+b+c+d<4.)

### TECHNICAL FIELD

The present invention relates to a novel organopolysiloxane which contains a sulfide group-containing organic group, and additionally relates to a rubber compounding ingredient, a rubber composition and a tire.

### BACKGROUND ART

Sulfur-containing organosilicon compounds are useful has essential ingredients in the manufacture of tires made of silica-filled rubber compositions. Silica-filled tires have an enhanced performance in automotive applications; the wear resistance, rolling resistance and wet grip properties in particular are outstanding. Such enhanced tire performance is closely associated with improved (lower) fuel consumption, and is currently under active investigation.

Increasing the silica loading of the rubber composition is essential for improving fuel consumption. However, although silica-filled rubber compositions lower the tire rolling resistance and improve the wet grip properties, there are problems with the workability in that such compositions have a high viscosity in the unvulcanized form and require, for example, multistage milling. Hence, in rubber compositions within which an inorganic filler such as silica is merely blended, one drawback is that, owing to inadequate dispersion of the filler, major decreases in the failure strength and wear resistance arise. Sulfur-containing organosilicon compounds have therefore been essential for increasing the dispersibility of inorganic filler in rubber and also for inducing chemical bonding between the filler and the rubber matrix (Patent Document 1: JP-B S51-20208).

Compounds which include an alkoxysilyl group and a polysulfide silyl group on the molecule, such as bis(triethoxysilylpropyl)tetrasulfide and bis(triethoxysilylpropyl)disulfide, are known to be effective as sulfur-containing organosilicon compounds (Patent Documents 2 to 5: JP-A 2004-525230, JP-A 2004-18511, JP-A 2002-145890 and U.S. Pat. No. 6,229,036).

Aside from the above polysulfide group-containing organosilicon compounds, the use of the following compounds is also known: thioester-type blocked mercapto group-containing organosilicon compounds which are advantageous for silica dispersibility, and sulfur-containing organosilicon compounds of a type obtained by transesterification of an amino alcohol with a hydrolyzable silyl group moiety advantageous for affinity with silica via hydrogen bonds (Patent Documents 6 to 10: JP-A 2005-8639, JP-A 2008-150546, JP-A 2010-132604, JP No. 4571125, U.S. Pat. No. 6,414,061).

However, even with the use of such sulfur-containing organosilicon compounds, rubber compositions for tires that realize the desired low fuel consumption properties have yet to be obtained. Moreover, aside from the high costs compared with sulfide compounds, various other challenges remain, such as problems with productivity on account of the complex manufacturing process.

Patent Document 11 (JP Pat. No. 5574063) presents examples in which polysiloxanes having polysulfide groups and long-chain alkyl groups are used. However, the sulfide equivalent weight is large and so rubber compositions for tires that achieve the desired low fuel consumption properties are not obtained.

### PRIOR ART DOCUMENTS

### Patent Documents

Patent Document 1: JP-B S51-20208

Patent Document 2: JP-A 2004-525230

Patent Document 3: JP-A 2004-18511

Patent Document 4: JP-A 2002-145890

Patent Document 5: U.S. Pat. No. 6,229,036

Patent Document 6: JP-A 2005-8639

Patent Document 7: JP-A 2008-150546

Patent Document 8: JP-A 2010-132604

Patent Document 9: JP Pat. No. 4571125

Patent Document 10: U.S. Pat. No. 6,414,061

Patent Document 11: JP Pat. No. 5574063

### SUMMARY OF THE INVENTION

### Problems to be Solved by the Invention

The present invention was arrived at in light of the above circumstances. An object of the invention is to provide an organopolysiloxane which, when used in tire production, achieves the desired low fuel consumption properties and is able to greatly reduce hysteresis loss in the cured rubber composition. Other objects of the invention are to provide a rubber compounding ingredient containing this organopolysiloxane, a rubber composition formulated with the rubber compounding ingredient, and a tire formed using the rubber composition.

### Means for Solving the Problems

The inventors have conducted extensive investigations in order to achieve the above objects. As a result, they have discovered that rubber compositions which use a rubber compounding ingredient composed primarily of an organopolysiloxane that contains a sulfide group-containing organic group, a monovalent hydrocarbon group of 5 to 10 carbon atoms such as a long-chain alkyl group and a hydrolyzable group and/or a hydroxyl group, and which have a sulfide equivalent weight of not more than 1,000 g/mol satisfy the low fuel consumption properties desired of tires.

Accordingly, the invention provides the following organopolysiloxane, rubber compounding ingredient, rubber composition and tire.
[1] An organopolysiloxane of average compositional formula (1) below which contains a sulfide group-containing organic group and has a sulfide equivalent weight of not more than 1,000 g/mol

(A)ₐ(B)_{b}(C)_{c}(R¹)_{d}SiO_{(4-2a-b-c-d)/2} (1)

wherein A is a sulfide group-containing divalent organic group, B is a monovalent hydrocarbon group of 5 to 10 carbon atoms, C is a hydrolyzable group and/or a hydroxyl group, R¹ is a monovalent hydrocarbon group of 1 to 4 carbon atoms, and the subscripts a, b, c and d satisfy the conditions 0<2a<1, 0<b<1, 0 <c<3, 0≦d<2 and 0<2a+b+c+d<4.
[2] The organopolysiloxane of [1], wherein the sulfide group-containing divalent organic group A has formula (2) below

*—(CH₂)ₙ—Sₓ—(CH₂)ₙ—* (2)

wherein n is an integer from 1 to 10, x is a statistical average value from 1 to 6, and *— and —* represent bonding sites; and the hydrolyzable group and/or hydroxyl group C has formula (3) below

*—OR² (3)

wherein R² is an alkyl group of 1 to 20 carbon atoms, an aryl group of 6 to 10 carbon atoms, an aralkyl group of 7 to 10 carbon atoms, an alkenyl group of 2 to 20 carbon atoms, or a hydrogen atom, and *— represents a bonding site.
[3] The organopolysiloxane of [1] or [2], wherein B in average compositional formula (1) is a monovalent hydrocarbon group of 8 to 10 carbon atoms.
[4] The organopolysiloxane of any of [1] to [3], wherein the sulfide equivalent weight is from 500 to 800 g/mol.
[5] An organopolysiloxane comprising a co-hydrolytic condensation product of:

20 to 95 mol % of an organosilicon compound of general formula (4) below

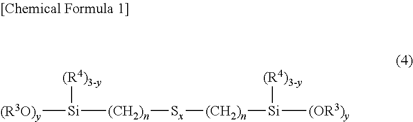

wherein n is an integer from 1 to 10, x is a statistical average value from 1 to 6, R³ is an alkyl group of 1 to 20 carbon atoms, an aryl group of 6 to 10 carbon atoms, an aralkyl group of 7 to 10 carbon atoms, or an alkenyl group of 2 to 10 carbon atoms, R⁴ is an alkyl group of 1 to 10 carbon atoms or an aryl group of 6 to 10 carbon atoms, and y is an integer from 1 to 3;

5 to 80 mol % of an organosilicon compound of general formula (5) below

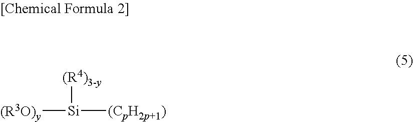

wherein R³, R⁴ and y are as defined above, and p is an integer from 5 to 10; and

0 to 10 mol % of an organosilicon compound of general formula (6) below

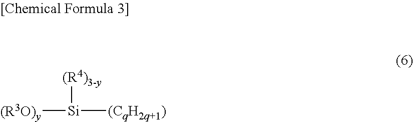

wherein R³, R⁴ and y are as defined above, and q is an integer from 1 to 4.
[6] A rubber compounding ingredient comprising the organopolysiloxane of any of [1] to [5].
[7] The rubber compounding ingredient of [6], further comprising at least one type of powder, wherein the weight ratio of the organopolysiloxane (A) to the at least one type of powder (B), expressed as (A)/(B), is from 70/30 to 5/95.
[8] A rubber composition comprising the rubber compounding ingredient of [6] or [7].
[9] A tire formed using the rubber composition of [8].

### ADVANTAGEOUS EFFECTS OF THE INVENTION

Because the organopolysiloxane of the invention contains, respectively, a sulfide group-containing organic group, a monovalent hydrocarbon groups of 5 to 10 carbon atoms such as a long-chain alkyl group and a hydrolyzable group and/or hydroxyl group, and moreover because it has a relatively small sulfide equivalent weight and thus a high sulfide group content, tires formed using a rubber composition in which a rubber compounding ingredient composed primarily of this organopolysiloxane is used are able to satisfy the low fuel consumption properties desired of tires.

### EMBODIMENT FOR CARRYING OUT THE INVENTION

The organopolysiloxane containing, respectively, a sulfide group-containing organic group, a monovalent hydrocarbon group of 5 to 10 carbon atoms such as a long-chain alkyl group and a hydrolyzable group and/or a hydroxyl group is represented by average compositional formula (1) below and has a sulfide equivalent weight of not more than 1,000 g/mol.

(A)ₐ(B)_{b}(C)_{c}(R¹)_{d}SiO_{(4-2a-b-c-d)/2} (1)

In the formula, A is a sulfide group-containing divalent organic group, B is a monovalent hydrocarbon group of 5 to 10 carbon atoms, C is a hydrolyzable group and/or a hydroxyl group, R¹ is a monovalent hydrocarbon group of 1 to 4 carbon atoms, and the subscripts a, b, c and d satisfy the conditions 0<2a<1, 0<b<1, 0<c<3, 0≦d<2 and 0<2a+b+c+d<4.

In formula (1), A is a sulfide group-containing divalent organic group, preferably one having formula (2) below

*—(CH₂)ₙ—Sₓ—(CH₂)ₙ—* (2)

In this formula, n is an integer from 1 to 10, preferably from 2 to 4; x is a statistical average value from 1 to 6, preferably from 2 to 4; and *— and —* represent bonding sites.

Examples of the sulfide group-containing divalent organic group include

—CH₂—S₂—CH₂—,

—C₂H₄—S₂—C₂H₄—,

—C₃H₆—S₂—C₃H₆—,

—C₄H₈—S₂—C₄H₈—,

—CH₂—S₄—CH₂—,

—C₂H₄—S₄—C₂H₄—,

—C₃H₆—S₄—C₃H₆—, and

—C₄H₈—S₄—C₄H₈—.

B is a monovalent hydrocarbon group of 5 to 10 carbon atoms, preferably 8 to 10 carbon atoms. Exemplary monovalent hydrocarbon groups include alkyl groups of 5 to 10 carbon atoms, such as linear, branched or cyclic pentyl, hexyl, octyl and decyl groups; and aryl groups of 6 to 10 carbon atoms, such as phenyl, tolyl and naphthyl groups. Linear, branched or cyclic alkyl groups are preferred; of these, octyl and decyl groups are more preferred.

C is a hydrolyzable group and/or a hydroxyl group, preferably one of formula (3) below.

*—OR² (3)

In this formula, R² is an alkyl group of 1 to 20, preferably 1 to 5, and more preferably 1 to 3 carbon atoms, an aryl group of 6 to 10 carbon atoms, an aralkyl group of 7 to 10 carbon atoms, an alkenyl group of 2 to 10, and preferably 2 to 4 carbon atoms, or a hydrogen atom. Also, *— represents a bonding site. The proportion of the —OR² groups that are —OH groups (where R² is a hydrogen atom) is preferably from 0 to 30 mol %, and more preferably from 0 to 10 mol %.

In formula (3), examples of alkyl groups that may serve as R² include methyl, ethyl, propyl, butyl, hexyl, octyl, decyl and octadecyl groups; examples of aryl groups include phenyl, tolyl and naphthyl groups; examples of aralkyl groups include the benzyl group; and examples of alkenyl groups include vinyl, propenyl and pentenyl groups. Of these R² is preferably an ethyl group.

In formula (1), R¹ is a monovalent hydrocarbon group of 1 to 4 carbon atoms. Examples of monovalent hydrocarbon groups include alkyl groups such as methyl, ethyl and propyl groups. Of these, a methyl group is preferred.

The subscripts a, b, c and d satisfy the conditions 0<2a<1, 0<b<1, 0 <c<3, 0≦d≦2 and 0<2a+b+c+d<4. In order to set the subsequently described sulfide equivalent weight within the prescribed range, it is preferable for 0.2≦2a≦0.95, 0.05≦b≦0.8, 1≦c≦2, 0≦d≦0.1 and 1.3≦2a+b+c+d<4; and more preferable for 0.4≦2a≦0.95, 0.05≦b≦0.6, 1≦c≦1.7, 0≦d≦0.05 and 1.5≦2a+b+c+d<4.

Here, a, b and d signify the average number of moles of the respective organic groups when the total number of moles of silicon atoms is 1, and thus indicate the average mol % of the respective organic groups included per molecule. The reason for using the notation “2a” is that A represents a divalent organic group. In addition, c indicates the average mol % of hydrolyzable groups included on silicon atoms per mole of silicon atoms.

The organopolysiloxane of the invention has a sulfide equivalent weight of not more than 1,000 g/mol. The sulfide equivalent weight is preferably from 500 to 900 g/mol, and more preferably from 500 to 800 g/mol.

As used herein, the “sulfide equivalent weight” of an organopolysiloxane refers to the weight of the organopolysiloxane that contains 1 mole of sulfide groups, and is derived from the following formula.

Sulfide equivalent weight=32.1×e×100/f (g/mol)

In the formula, e is the average sulfur chain length of the sulfide group, and f is the sulfur content (wt %) within the organopolysiloxane.

At a sulfide equivalent weight greater than 1,000 g/mol, the dispersibility in rubber of the filler when used as a treatment agent is inadequate, as a result of which, for instance, the wear resistance and rollability of silica-filled tires may be inferior; that is, the desired effects are not obtained. In the organopolysiloxane of the invention, in order to have the sulfide equivalent weight fall within the above range, it is preferable to set the subscripts a to d in formula (1) within the ranges indicated above. A sulfide equivalent weight within the prescribed range can be achieved by, for example, adjusting the proportions in which the various organosilicon compounds serving as starting materials are reacted during preparation of the organopolysiloxane in such a way as to satisfy the respective ranges for a to d above.

The sulfur content within the organopolysiloxane of the invention is preferably from 6 to 30 wt %, and more preferably from 7 to 28 wt %. When the sulfur content is too low, the sulfide equivalent weight becomes larger, as a result of which the desired rubber properties may not be obtained. When the sulfur content is too high, no further improvements in the advantageous effects are obtained, making such a high sulfur content uneconomical. The sulfur content is the value measured by elemental analysis using, for example, a Mod-1106 analyzer from CARLO ERBA.

The organopolysiloxane of the invention has a viscosity which is preferably from 2 mm²/s to 10,000 mm²/s, and more preferably from 10 mm²/s to 5,000 mm²/s. When the viscosity is too large, the processability may worsen. The viscosity is based on measurements taken at 25° C. with a capillary-type kinematic viscometer.

Preparation of the organopolysiloxane of the invention is carried out by the co-hydrolytic condensation of: an organosilicon compound of general formula (4) below

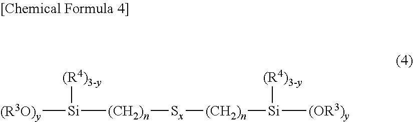

(wherein n and x are as defined above; R³ is an alkyl group of 1 to 20, preferably 1 to 5, and more preferably 1 to 3 carbon atoms, an aryl group of 6 to 10 carbon atoms, an aralkyl group of 7 to 10 carbon atoms, or an alkenyl group of 2 to 10, and preferably 2 to 4 carbon atoms; R⁴ is an alkyl group of 1 to 10, and preferably 1 to 3 carbon atoms or an aryl group of 6 to 10 carbon atoms; and y is an integer from 1 to 3, and especially 2 or 3), an organosilicon compound of general formula (5) below

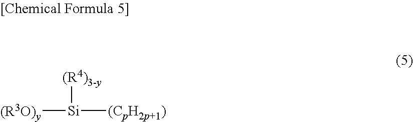

(wherein R³, R⁴ and y are as defined above, and p is an integer from 5 to 10, and preferably from 8 to 10), and, optionally, an organosilicon compound of general formula (6) below

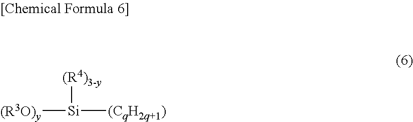

(wherein R³, R⁴ and y are as defined above, and q is an integer from 1 to 4, and preferably from 1 to 3).

In above formulas (4) to (6), examples of alkyl groups that may serve as R³ include methyl, ethyl, propyl, butyl, hexyl, octyl, decyl and octadecyl groups; examples of aryl groups include phenyl, tolyl and naphthyl groups; examples of aralkyl groups include the benzyl group; and examples of alkenyl groups include vinyl, propenyl and pentenyl groups. Of these R³ is preferably an ethyl group.

Examples of alkyl groups that may serve as R⁴ include methyl, ethyl, propyl, butyl, hexyl, octyl and decyl groups; and examples of aryl groups include phenyl, tolyl and naphthyl groups. Of these, R⁴ is preferably a methyl group.

Examples of the organosilicon compound of formula (4) include, without particular limitation, bis(trimethoxysilylpropyl)tetrasulfide, bis(triethoxysilylpropyl)tetrasulfide, bis(trimethoxysilylpropyl)disulfide and bis(triethoxysilylpropyl)disulfide.

Examples of the organosilicon compound of formula (5) include, without particular limitation, pentyltrimethoxysilane, pentylmethyldimethoxysilane, pentyltriethoxysilane, pentylmethyldiethoxysilane, hexyltrimethoxysilane, hexylmethyldimethoxysilane, hexyltriethoxysilane, hexylmethyldiethoxysilane, octyltrimethoxysilane, octylmethyldimethoxysilane, octyltriethoxysilane, octylmethyldiethoxysilane, decyltrimethoxysilane, decylmethyldimethoxysilane, decyltriethoxysilane and decylmethyldiethoxysilane.

Examples of the organosilicon compound of formula (6) include, without particular limitation, methyltrimethoxysilane, dimethyldimethoxysilane, methyltriethoxysilane, methylethyldiethoxysilane, propyltrimethoxysilane, propylmethyldimethoxysilane and propylmethyldiethoxysilane.

Here, the amounts of the organosilicon compounds of formulas (4), (5) and (6) used are selected in such a way as to set subscripts a to d in formula (1) within the above-indicated ranges. Specifically, with respect to the overall amount of the organosilicon compounds of formulas (4), (5) and (6), the organosilicon compound of formula (4) is used in an amount of preferably 20 to 95 mol %, more preferably 30 to 95 mol %, and especially 40 to 95 mol %; the organosilicon compound of formula (5) is used in an amount of preferably 5 to 80 mol %, more preferably 5 to 70 mol %, and especially 5 to 60 mol %; and the organosilicon compound of formula (6) is used in an amount of preferably 0 to 10 mol %, and more preferably 0 to 5 mol %.

Co-hydrolytic condensation may be carried out by a known method. The amount of water used may also be set to a known amount. In general, from 0.5 to 0.99 mole, and more preferably from 0.5 to 0.9 mole, per mole of the sum of the hydrolyzable silyl groups in the organosilicon compound may be used.

Where necessary, an organic solvent may be used to prepare the organopolysiloxane of the invention. Examples of the solvent include, without particular limitation, aliphatic hydrocarbon solvents such as pentane, hexane, heptane and decane; ether solvents such as diethyl ether, tetrahydrofuran and 1,4-dioxane; amide solvents such as formamide, dimethylformamide and N-methylpyrrolidone; aromatic hydrocarbon solvents such as benzene, toluene and xylene; and alcohol solvents such as methanol, ethanol and propanol. Of these, from the standpoint of outstanding hydrolytic reactivity, ethanol and i-propanol are preferred. When using such a solvent, the amount of use is not particularly limited, although it is preferably not more than about twice the weight of the organosilicon compound, and more preferably not more than about the same weight as the organosilicon compound.

Also, where necessary, a catalyst may be used to prepare the organopolysiloxane of the invention. Examples of the catalyst include, without particular limitation, acidic catalysts such as hydrochloride acid and acetic acid; Lewis acid catalysts such as tetrabutyl orthotitanate and ammonium fluoride; alkali metal salts such as sodium hydroxide, potassium hydroxide, sodium carbonate, sodium acetate, potassium acetate, sodium bicarbonate, potassium carbonate, potassium bicarbonate, calcium carbonate, sodium methoxide and sodium ethoxide; and amine compounds such as triethylamine, tributylamine, pyridine and 4-dimethylaminopyridine. An example of a catalyst that may be used for the hydrolysis (and/or partial condensation) of silane is hydrochloric acid. An example of a catalyst that may be used for the condensation (oligomerization) of silanol is potassium hydroxide. The amount of catalyst (when a silane hydrolysis reaction catalyst and a silanol condensation reaction catalyst are used together, the amounts of each), from the standpoint of excellent reactivity, is preferably from 0.001 to 0.05 (unit: mole equivalent) per mole of the sum of the hydrolyzable silyl groups in the organosilicon compound.

Co-hydrolytic condensation is typically carried out at 20 to 100° C., especially 60 to 85° C., and for 30 minutes to 20 hours, especially 1 minute to 10 hours.

The rubber compounding ingredient of the invention includes the organopolysiloxane (A) of the invention. Alternatively, a mixture obtained by mixing the organopolysiloxane (A) of the invention beforehand with at least one type of powder (B) may be used as the rubber compounding ingredient. Examples of the powder (B) include carbon black, talc, calcium carbonate, stearic acid, silica, aluminum hydroxide, alumina and magnesium hydroxide. From the standpoint of the reinforcing properties, silica and aluminum hydroxide are preferred. Silica is especially preferred.

The content of the powder (B), expressed as the weight ratio of component (A) to component (B) ((A)/(B)), is preferably from 70/30 to 5/95, and more preferably from 60/40 to 10/90. When the amount of the powder (B) is too small, the rubber compounding ingredient becomes liquid and charging into a rubber mixer may be difficult. When the amount of the powder (B) is too large, the overall amount relative to the effective dose of rubber compounding ingredient becomes high, as a result of which the transport costs may rise.

The rubber compounding ingredient of the invention may be mixed with a fatty acid, a fatty acid salt, or an organic polymer or rubber such as polyethylene, polypropylene, polyoxyalkylene, polyester, polyurethane, polystyrene, polybutadiene, polyisoprene, natural rubber or styrene-butadiene copolymer. Various types of additives that are commonly included in rubber compositions for use in tires and for use in other common rubbers, such as vulcanizing agents, crosslinking agents, vulcanization accelerators, crosslinking accelerators, and various oils, antioxidants, fillers and plasticizers, may also be included. The rubber compounding ingredient may be in the form of a liquid or solid, or may be in a form obtained by dilution in an organic solvent or by emulsification.

The rubber compounding ingredient of the invention is preferably used in rubber compositions containing a filler, and especially silica.

In this case, it is desirable for the rubber compounding ingredient to be added in an amount, per 100 parts by weight of the filler included in the rubber composition, of from 0.2 to 30 parts by weight, and especially from 1 to 20 parts by weight. When the amount of organopolysiloxane added is too small, the desired rubber properties may not be obtained. On the other hand, when it is too large, no further improvements in the advantageous effects are obtained for the amount of addition, making further addition uneconomical.

Here, the rubber included as the chief constituent in the rubber composition that uses the rubber compounding ingredient of the invention may be any rubber that has hitherto been commonly included in various types of rubber compositions. For example, the following may be used, either singly or as blends thereof: natural rubbers (NR), isoprene rubbers (IR), diene rubbers such as various types of styrene-butadiene copolymer rubbers (SBR), various types of polybutadiene rubbers (BR), acrylonitrile-butadiene copolymer rubbers (NBR) and butyl rubbers (BR), and ethylene-propylene copolymer rubbers (EPR, EPDM). The filler included is exemplified by silica, talc, clay, aluminum hydroxide, magnesium hydroxide, calcium carbonate and titanium oxide. The filler content may be set to a content commonly used in the art, provided that doing so does not work against the objects of the invention.

Rubber compositions which use the rubber compounding ingredient of the invention may further include, in addition to the above essential ingredients: various additives that are commonly included in rubber compositions for use in tires and for use in other common rubbers, such as carbon black, vulcanizing agents, crosslinking agents, vulcanization accelerators, crosslinking accelerators, and various oils, antioxidants and plasticizers. The contents of these additives may be set to ordinary levels hitherto used in the art, provided that doing so does not work against the objects of the invention.

In these rubber compositions, although it is also possible for the organopolysiloxane of the invention to substitute for a known silane coupling agent, another silane coupling agent may be optionally added as well; any silane coupling agent that has hitherto been used together with a silica filler may be added. Typical examples of such silane coupling agents include vinyltrimethoxysilane, vinyltriethoxysilane, γ-glycidoxypropyltrimethoxysilane, ≢5-glycidoxypropyltriethoxysilane, γ-aminopropyltriethoxysilane, β-aminoethyl-γ-aminopropyltrimethoxysilane, β-aminoethyl-γ-aminopropyltriethoxysilane, γ-mercaptopropyltrimethoxysilane, γ-mercaptopropyltriethoxysilane, γ-methacryloxypropyltrimethoxysilane, γ-methacryloxypropyltriethoxysilane, γ-acryloxypropyltrimethoxysilane, γ-acryloxypropyltriethoxysilane, bis(triethoxysilylpropyl)tetrasulfide and bis(triethoxysilylpropyl)disulfide.

Rubber compositions formulated with the rubber compounding ingredient of the invention can be used after being kneaded and rendered into a composition by an ordinary method and then vulcanized or crosslinked.

The tire of the invention is characterized by using the above-described rubber composition, with this rubber composition preferably being used in the treads. The tire of the invention has a greatly reduced rolling resistance and also has a greatly enhanced wear resistance, thus enabling the desired low fuel consumption to be achieved. Also, the tire of the invention has a hitherto known structure that is not particularly limited, and can be manufactured by an ordinary process. In cases where the tire of the invention is a pneumatic tire, the gas used to fill the interior of the tire may be ordinary air or air having a regulated oxygen partial pressure, or may be an inert gas such as nitrogen, argon or helium.

### EXAMPLES

The invention is illustrated more fully below by way of Working Examples and Comparative Examples, although these Examples are not intended to limit the invention. In the following Examples, parts are given by weight, “Et” stands for an ethyl group, and elemental analysis was carried out by measurement with a Mod-1106 analyzer from CARLO ERBA. The viscosities are values measured at 25° C. using a capillary-type kinematic viscometer.

### Working Example 1

A one-liter separable flask equipped with a stirrer, a reflux condenser, a dropping funnel and a thermometer was charged with 161.7 g (0.3 mol) of bis(triethoxysilylpropyl)tetrasulfide (KBE-846, from Shin-Etsu Chemical Co., Ltd.), 165.9 g (0.6 mol) of octyltriethoxysilane (KBE-3083, from Shin-Etsu Chemical Co., Ltd.) and 162.0 g of ethanol, following which 16.2 g of 0.5 N aqueous hydrochloric acid (water, 0.9 mol) was added dropwise at room temperature. The flask contents were then stirred for 2 hours at 80° C., after which filtration was carried out, followed by the dropwise addition of 7.8 g of a 5 wt % KOH/EtOH solution and 2 hours of stirring at 80° C. Vacuum concentration and filtration afforded a clear brown liquid having a viscosity of 80 mm²/s. Elemental analysis was carried out, whereupon the resulting silicone oligomer was found to have a sulfur content of 14.7 wt %, a sulfide equivalent weight of 870 g/mol and the average compositional formula shown below. This oligomer was called Oligomer 1.

(—C₃H₆—S₄—C₃H₆—)_{0.25}(—C₈H₁₇)_{0.50}(—OC₂H₅)_{1.50}SiO_{0.75}

### Working Example 2

A one-liter separable flask equipped with a stirrer, a reflux condenser, a dropping funnel and a thermometer was charged with 161.7 g (0.3 mol) of bis(triethoxysilylpropyl)tetrasulfide (KBE-846, from Shin-Etsu Chemical Co., Ltd.), 138.3 g (0.5 mol) of octyltriethoxysilane (KBE-3083, from Shin-Etsu Chemical Co., Ltd.) and 162.0 g of ethanol, following which 14.9 g of 0.5 N aqueous hydrochloric acid (water, 0.83 mol) was added dropwise at room temperature. The flask contents were then stirred for 2 hours at 80° C., after which filtration was carried out, followed by the dropwise addition of 7.2 g of a 5 wt % KOH/EtOH solution and 2 hours of stirring at 80° C. Vacuum concentration and filtration afforded a clear brown liquid having a viscosity of 220 mm²/s. Elemental analysis was carried out, whereupon the resulting silicone oligomer was found to have a sulfur content of 16.1 wt %, a sulfide equivalent weight of 796 g/mol and the average compositional formula shown below. This oligomer was called Oligomer 2.

(—C₃H₆—S₄—C₃H₆—)_{0.27}(—C₈H₁₇)_{0.45}(—OC₂H₅)_{1.50}SiO_{0.75}

### Working Example 3

A one-liter separable flask equipped with a stirrer, a reflux condenser, a dropping funnel and a thermometer was charged with 161.7 g (0.3 mol) of bis(triethoxysilylpropyl)tetrasulfide (KBE-846, from Shin-Etsu Chemical Co., Ltd.), 110.6 g (0.4 mol) of octyltriethoxysilane (KBE-3083, from Shin-Etsu Chemical Co., Ltd.) and 162.0 g of ethanol, following which 13.5 g of 0.5 N aqueous hydrochloric acid (water, 0.75 mol) was added dropwise at room temperature. The flask contents were then stirred for 2 hours at 80° C., after which filtration was carried out, followed by the dropwise addition of 6.5 g of a 5 wt % KOH/EtOH solution and 2 hours of stirring at 80° C. Vacuum concentration and filtration afforded a clear brown liquid having a viscosity of 800 mm²/s. Elemental analysis was carried out, whereupon the resulting silicone oligomer was found to have a sulfur content of 17.8 wt %, a sulfide equivalent weight of 723 g/mol and the average compositional formula shown below. This oligomer was called Oligomer 3.

(—C₃H₆—S₄—C₃H₆—)_{0.30}(—C₈H₁₇)_{0.40}(—OC₂H₅)_{1.50}SiO_{0.75}

### Working Example 4

A one-liter separable flask equipped with a stirrer, a reflux condenser, a dropping funnel and a thermometer was charged with 161.7 g (0.3 mol) of bis(triethoxysilylpropyl)tetrasulfide (KBE-846, from Shin-Etsu Chemical Co., Ltd.), 83.0 g (0.3 mol) of octyltriethoxysilane (KBE-3083, from Shin-Etsu Chemical Co., Ltd.) and 162.0 g of ethanol, following which 12.2 g of 0.5 N aqueous hydrochloric acid (water, 0.68 mol) was added dropwise at room temperature. The flask contents were then stirred for 2 hours at 80° C., after which filtration was carried out, followed by the dropwise addition of 5.9 g of a 5 wt % KOH/EtOH solution and 2 hours of stirring at 80° C. Vacuum concentration and filtration afforded a clear brown liquid having a viscosity of 2,000 mm²/s. Elemental analysis was carried out, whereupon the resulting silicone oligomer was found to have a sulfur content of 19.8 wt %, a sulfide equivalent weight of 649 g/mol and the average compositional formula shown below. This oligomer was called Oligomer 4.

(—C₃H₆—S₄—C₃H₆—)_{0.33}(—C₈H₁₇)_{0.33}(—OC₂H₅)_{1.50}SiO_{0.75}

### Working Example 5

A one-liter separable flask equipped with a stirrer, a reflux condenser, a dropping funnel and a thermometer was charged with 210.2 g (0.39 mol) of bis(triethoxysilylpropyl)tetrasulfide (KBE-846, from Shin-Etsu Chemical Co., Ltd.), 83.0 g (0.3 mol) of octyltriethoxysilane (KBE-3083, from Shin-Etsu Chemical Co., Ltd.) and 162.0 g of ethanol, following which 13.0 g of 0.5 N aqueous hydrochloric acid (water, 0.72 mol) was added dropwise at room temperature. The flask contents were then stirred for 2 hours at 80° C., after which filtration was carried out, followed by the dropwise addition of 6.3 g of a 5 wt % KOH/EtOH solution and 2 hours of stirring at 80° C. Vacuum concentration and filtration afforded a clear brown liquid having a viscosity of 70 mm²/s. Elemental analysis was carried out, whereupon the resulting silicone oligomer was found to have a sulfur content of 20.9 wt %, a sulfide equivalent weight of 615 g/mol and the average compositional formula shown below. This oligomer was called Oligomer 5.

(—C₃H₆—S₄—C₃H₆—)_{0.36}(—C₈H₁₇)_{0.28}(—OC₂H₅)_{1.67}SiO_{0.67}

### Working Example 6

A one-liter separable flask equipped with a stirrer, a reflux condenser, a dropping funnel and a thermometer was charged with 231.8 g (0.43 mol) of bis(triethoxysilylpropyl)tetrasulfide (KBE-846, from Shin-Etsu Chemical Co., Ltd.), 83.0 g (0.3 mol) of octyltriethoxysilane (KBE-3083, from Shin-Etsu Chemical Co., Ltd.) and 162.0 g of ethanol, following which 13.9 g of 0.5 N aqueous hydrochloric acid (water, 0.77 mol) was added dropwise at room temperature. The flask contents were then stirred for 2 hours at 80° C., after which filtration was carried out, followed by the dropwise addition of 6.7 g of a 5 wt % KOH/EtOH solution and 2 hours of stirring at 80° C. Vacuum concentration and filtration afforded a clear brown liquid having a viscosity of 220 mm²/s. Elemental analysis was carried out, whereupon the resulting silicone oligomer was found to have a sulfur content of 21.4 wt %, a sulfide equivalent weight of 599 g/mol and the average compositional formula shown below. This oligomer was called Oligomer 6.

(—C₃H₆—S₄—C₃H₆—)_{0.37}(—C₈H₁₇)_{0.26}(—OC₂H₅)_{1.67}SiO_{0.67}

### Working Example 7

A one-liter separable flask equipped with a stirrer, a reflux condenser, a dropping funnel and a thermometer was charged with 247.9 g (0.46 mol) of bis(triethoxysilylpropyl)tetrasulfide (KBE-846, from Shin-Etsu Chemical Co., Ltd.), 83.0 g (0.3 mol) of octyltriethoxysilane (KBE-3083, from Shin-Etsu Chemical Co., Ltd.) and 162.0 g of ethanol, following which 14.6 g of 0.5 N aqueous hydrochloric acid (water, 0.81 mol) was added dropwise at room temperature. The flask contents were then stirred for 2 hours at 80° C., after which filtration was carried out, followed by the dropwise addition of 7.0 g of a 5 wt % KOH/EtOH solution and 2 hours of stirring at 80° C. Vacuum concentration and filtration afforded a clear brown liquid having a viscosity of 2,600 mm²/s. Elemental analysis was carried out, whereupon the resulting silicone oligomer was found to have a sulfur content of 21.8 wt %, a sulfide equivalent weight of 589 g/mol and the average compositional formula shown below. This oligomer was called Oligomer 7.

(—C₃H₆—S₄—C₃H₆—)_{0.38}(—C₈H₁₇)_{0.25}(—OC₂H₅)_{1.67}SiO_{0.67}

### Comparative Example 1

A one-liter separable flask equipped with a stirrer, a reflux condenser, a dropping funnel and a thermometer was charged with 107.8 g (0.2 mol) of bis(triethoxysilylpropyl)tetrasulfide (KBE-846, from Shin-Etsu Chemical Co., Ltd.), 276.5 g (1.0 mol) of octyltriethoxysilane (KBE-3083, from Shin-Etsu Chemical Co., Ltd.) and 162.0 g of ethanol, following which 18.9 g of 0.5 N aqueous hydrochloric acid (water, 1.05 mol) was added dropwise at room temperature. The flask contents were then stirred for 2 hours at 80° C., after which filtration was carried out, followed by the dropwise addition of 9.1 g of a 5 wt % KOH/EtOH solution and 2 hours of stirring at 80° C. Vacuum concentration and filtration afforded a clear brown liquid having a viscosity of 10 mm²/s. Elemental analysis was carried out, whereupon the resulting silicone oligomer was found to have a sulfur content of 8.4 wt %, a sulfide equivalent weight of 1.533 g/mol and the average compositional formula shown below. This oligomer was called Oligomer 8.

(—C₃H₆—S₄—C₃H₆—)_{0.14}(—C₈H₁₇)_{0.71}(—OC₂H₅)_{1.50}SiO_{0.75}

### Comparative Example 2

A one-liter separable flask equipped with a stirrer, a reflux condenser, a dropping funnel and a thermometer was charged with 107.8 g (0.2 mol) of bis(triethoxysilylpropyl)tetrasulfide (KBE-846, from Shin-Etsu Chemical Co., Ltd.), 221.2 g (0.8 mol) of octyltriethoxysilane (KBE-3083, from Shin-Etsu Chemical Co., Ltd.) and 162.0 g of ethanol, following which 16.2 g of 0.5 N aqueous hydrochloric acid (water, 0.9 mol) was added dropwise at room temperature. The flask contents were then stirred for 2 hours at 80° C., after which filtration was carried out, followed by the dropwise addition of 7.8 g of a 5 wt % KOH/EtOH solution and 2 hours of stirring at 80° C. Vacuum concentration and filtration afforded a clear brown liquid having a viscosity of 20 mm²/s. Elemental analysis was carried out, whereupon the resulting silicone oligomer was found to have a sulfur content of 9.8 wt %, a sulfide equivalent weight of 1.312 g/mol and the average compositional formula shown below. This oligomer was called Oligomer 9.

(—C₃H₆—S₄—C₃H₆—)_{0.17}(—C₈H₁₇)_{0.67}(—OC₂H₅)_{1.50}SiO_{0.75}

### Comparative Example 3

A one-liter separable flask equipped with a stirrer, a reflux condenser, a dropping funnel and a thermometer was charged with 107.8 g (0.2 mol) of bis(triethoxysilylpropyl)tetrasulfide (KBE-846, from Shin-Etsu Chemical Co., Ltd.), 165.9 g (0.6 mol) of octyltriethoxysilane (KBE-3083, from Shin-Etsu Chemical Co., Ltd.) and 162.0 g of ethanol, following which 13.5 g of 0.5 N aqueous hydrochloric acid (water, 0.75 mol) was added dropwise at room temperature. The flask contents were then stirred for 2 hours at 80° C., after which filtration was carried out, followed by the dropwise addition of 6.5 g of a 5 wt % KOH/EtOH solution and 2 hours of stirring at 80° C. Vacuum concentration and filtration afforded a clear brown liquid having a viscosity of 35 mm²/s. Elemental analysis was carried out, whereupon the resulting silicone oligomer was found to have a sulfur content of 11.8 wt %, a sulfide equivalent weight of 1,091 g/mol and the average compositional formula shown below. This oligomer was called Oligomer 10.

(—C₃H₆—S₄—C₃H₆—)_{0.20}(—C₈H₁₇)_{0.60}(—OC₂H₅)_{1.50}SiO_{0.75}

### Comparative Example 4

A one-liter separable flask equipped with a stirrer, a reflux condenser, a dropping funnel and a thermometer was charged with 161.7 g (0.3 mol) of bis(triethoxysilylpropyl)tetrasulfide (KBE-846, from Shin-Etsu Chemical Co., Ltd.), 61.9 g (0.3 mol) of propyltriethoxysilane (KBE-3033, from Shin-Etsu Chemical Co., Ltd.) and 162.0 g of ethanol, following which 12.2 g of 0.5 N aqueous hydrochloric acid (water, 0.68 mol) was added dropwise at room temperature. The flask contents were then stirred for 2 hours at 80° C., after which filtration was carried out, followed by the dropwise addition of 5.9 g of a 5 wt % KOH/EtOH solution and 2 hours of stirring at 80° C. Vacuum concentration and filtration afforded a clear brown liquid having a viscosity of 350 mm²/s. Elemental analysis was carried out, whereupon the resulting silicone oligomer was found to have a sulfur content of 22.2 wt %, a sulfide equivalent weight of 579 g/mol and the average compositional formula shown below. This oligomer was called Oligomer 11.

(—C₃H₆—S₄—C₃H₆—)_{0.33}(—C₈H₁₇)_{0.33}(—OC₂H₅)_{1.50}SiO_{0.75}

### Comparative Example 5

A one-liter separable flask equipped with a stirrer, a reflux condenser, a dropping funnel and a thermometer was charged with 247.9 g (0.46 mol) of bis(triethoxysilylpropyl)tetrasulfide (KBE-846, from Shin-Etsu Chemical Co., Ltd.), 61.9 g (0.3 mol) of propyltriethoxysilane (KBE-3033, from Shin-Etsu Chemical Co., Ltd.) and 162.0 g of ethanol, following which 14.6 g of 0.5 N aqueous hydrochloric acid (water, 0.81 mol) was added dropwise at room temperature. The flask contents were then stirred for 2 hours at 80° C., after which filtration was carried out, followed by the dropwise addition of 7.0 g of a 5 wt % KOH/EtOH solution and 2 hours of stirring at 80° C. Vacuum concentration and filtration afforded a clear brown liquid having a viscosity of 800 mm²/s. Elemental analysis was carried out, whereupon the resulting silicone oligomer was found to have a sulfur content of 23.6 wt %, a sulfide equivalent weight of 543 g/mol and the average compositional formula shown below. This oligomer was called Oligomer 12.

(—C₃H₆—S₄—C₃H₆—)_{0.38}(—C₈H₁₇)_{0.25}(—OC₂H₅)_{1.67}SiO_{0.67}

### Working Examples 8 to 14, Comparative Examples 6 to 11

As shown in Tables 1 and 2, masterbatches were prepared by blending together 110 parts of oil-extended emulsion-polymerized SBR (#1712 from JSR Corporation), 20 parts of NR (common grade RSS 3), 20 parts of carbon black (common grade N234), 50 parts of silica (Nipsil AQ, from Nippon Silica Industries), 6.5 parts of the oligomers in Working Examples 1 to 7 and Comparative Examples 1 to 5 or Comparative Compound A shown below, 1 part of stearic acid, and 1 part of the antioxidant 6D (Ouchi Shinko Chemical Industrial Co., Ltd.). Next, 3 parts of zinc white, 0.5 part of the vulcanization accelerator DM (dibenzothiazyl disulfide), 1 part of the vulcanization accelerator NS (N-t-butyl-2-benzothiazolyl sulfenamide) and 1.5 parts of sulfur were added to the above blend and kneaded, giving a rubber composition.

### Comparative Compound A

(EtO)₃Si—C₃H₆—S₄—C₃H₆—Si(OEt)₃ [Chemical Formula 7]

Next, the properties of the rubber compositions in the unvulcanized form and in the vulcanized form were measured by the following methods. The results are shown in Tables 1 and 2.

### [Properties of Unvulcanized Composition]

### (1) Mooney Viscosity

Measured in accordance with JIS K 6300 after allowing 1 minute for sample to reach thermal equilibrium with viscometer; measurement was carried out for 4 minutes at 130° C. The results are expressed as numbers relative to an arbitrary value of 100 for the result in Comparative Example 11. A smaller number indicates a lower Mooney viscosity and thus a better processability.

### [Properties of Vulcanized Composition]

### (2) Dynamic Viscoelasticity

Using a viscoelastic tester (Rheometrics), measurement was carried out at 5% dynamic strain under tension, a frequency of 15 Hz and 60° C. Using sheets having a thickness of 0.2 cm and a width of 0.5 cm as the test specimens, the clamping interval in the tester was set to 2 cm and the initial load was set to 160 g. The tan δ values are expressed as numbers relative to an arbitrary value of 100 for the result in Comparative Example 11. A smaller number indicates a smaller hysteresis loss and lower heat buildup.

### (3) Wear Resistance

Testing was carried out in general accordance with JIS K 6264-2: 2005 using a Lambourn abrasion tester under the following conditions: room temperature, 25% slip ratio. The results are expressed as numbers relative to an arbitrary value of 100 for the reciprocal of the abrasion loss in Comparative Example 11. A larger number indicates a lower abrasion loss and excellent wear resistance.

TABLE 1

| | Working Example | | | | | | |
|---|---|---|---|---|---|---|---|
| | 8 | 9 | 10 | 11 | 12 | 13 | 14 |
| Recipe (pbw) | | | | | | | |
| SBR | 110 | 110 | 110 | 110 | 110 | 110 | 110 |
| NR | 20 | 20 | 20 | 20 | 20 | 20 | 20 |
| Carbon black | 20 | 20 | 20 | 20 | 20 | 20 | 20 |
| Silica | 50 | 50 | 50 | 50 | 50 | 50 | 50 |
| Stearic acid | 1 | 1 | 1 | 1 | 1 | 1 | 1 |
| Antioxidant 6C | 1 | 1 | 1 | 1 | 1 | 1 | 1 |
| Zinc white | 3 | 3 | 3 | 3 | 3 | 3 | 3 |
| Vulcanizing | 0.5 | 0.5 | 0.5 | 0.5 | 0.5 | 0.5 | 0.5 |
| accelerator DM | | | | | | | |
| Vulcanizing | 1 | 1 | 1 | 1 | 1 | 1 | 1 |
| accelerator NS | | | | | | | |
| Sulfur | 1.5 | 1.5 | 1.5 | 1.5 | 1.5 | 1.5 | 1.5 |
| Oligomer 1 | 6.5 | — | — | — | — | — | — |
| Oligomer 2 | — | 6.5 | — | — | — | — | — |
| Oligomer 3 | — | — | 6.5 | — | — | — | — |
| Oligomer 4 | — | — | — | 6.5 | — | — | — |
| Oligomer 5 | — | — | — | — | 6.5 | — | — |
| Oligomer 6 | — | — | — | — | — | 6.5 | — |
| Oligomer 7 | — | — | — | — | — | — | 6.5 |
| [Properties of | | | | | | | |
| Unvulcanized | | | | | | | |
| Composition] | | | | | | | |
| Mooney viscosity | 99 | 98 | 96 | 99 | 98 | 99 | 98 |
| [Properties of Vulcanized | | | | | | | |
| Composition] | | | | | | | |
| Dynamic viscoelasticity, | 95 | 92 | 90 | 88 | 87 | 86 | 85 |
| tan δ (60° C.) | | | | | | | |
| Wear resistance | 105 | 105 | 106 | 108 | 110 | 110 | 112 |

TABLE 2

| | Comparative Example | | | | | |
|---|---|---|---|---|---|---|
| | 6 | 7 | 8 | 9 | 10 | 11 |
| Recipe (pbw) | | | | | | |
| SBR | 110 | 110 | 110 | 110 | 110 | 110 |
| NR | 20 | 20 | 20 | 20 | 20 | 20 |
| Carbon black | 20 | 20 | 20 | 20 | 20 | 20 |
| Silica | 50 | 50 | 50 | 50 | 50 | 50 |
| Stearic acid | I | I | 1 | 1 | 1 | 1 |
| Antioxidant 6C | I | I | 1 | 1 | 1 | 1 |
| Zinc white | 3 | 3 | 3 | 3 | 3 | 3 |
| Vulcanizing accelerator DM | 0.5 | 0.5 | 0.5 | 0.5 | 0.5 | 0.5 |
| Vulcanizing accelerator NS | 1 | 1 | 1 | 1 | 1 | 1 |
| Sulfur | 1.5 | 1.5 | 1.5 | 1.5 | 1.5 | 1.5 |
| Oligomer 8 | 6.5 | — | — | — | — | — |
| Oligomer 9 | — | 6.5 | — | — | — | — |
| Oligomer 10 | — | — | 6.5 | — | — | — |
| Oligomer 11 | — | — | — | 6.5 | — | — |
| Oligomer 12 | — | — | — | — | 6.5 | — |
| Comparative Compound A | — | — | — | — | — | 6.5 |
| [Properties of Unvulcanized | | | | | | |
| Composition] | | | | | | |
| Mooney viscosity | 98 | 99 | 97 | 98 | 95 | 100 |
| [Properties of Vulcanized | | | | | | |
| Composition] | | | | | | |
| Dynamic viscoelasticity, | 112 | 110 | 108 | 102 | 102 | 100 |
| tan δ (60° C.) | | | | | | |
| Wear resistance | 83 | 85 | 88 | 92 | 92 | 100 |

1. An organopolysiloxane of average compositional formula (1) below which contains a sulfide group-containing organic group and has a sulfide equivalent weight of not more than 1,000 g/mol
(A)ₐ(B)_{b}(C)_{c}(R¹)_{d}SiO_{(4-2a-b-c-d)/2} (1)
wherein A is a sulfide group-containing divalent organic group, B is a monovalent hydrocarbon group of 5 to 10 carbon atoms, C is a hydrolyzable group and/or a hydroxyl group, R¹ is a monovalent hydrocarbon group of 1 to 4 carbon atoms, and the subscripts a, b, c and d satisfy the conditions 0<2a<1, 0<b<1, 0<c<3, 0≦d<2 and 0<2a+b+c+d<4.

2. The organopolysiloxane of claim 1, wherein the sulfide group-containing divalent organic group A has formula (2) below
*—(CH₂)ₙ—Sₓ—(CH₂)ₙ—* (2)
wherein n is an integer from 1 to 10, x is a statistical average value from 1 to 6, and *— and —* represent bonding sites; and the hydrolyzable group and/or hydroxyl group C has formula (3) below
*—OR² (3)
wherein R² is an alkyl group of 1 to 20 carbon atoms, an aryl group of 6 to 10 carbon atoms, an aralkyl group of 7 to 10 carbon atoms, an alkenyl group of 2 to 20 carbon atoms, or a hydrogen atom, and *— represents a bonding site.

3. The organopolysiloxane of claim 1 or 2, wherein B in average compositional formula (1) is a monovalent hydrocarbon group of 8 to 10 carbon atoms.

4. The organopolysiloxane of claim 1, wherein the sulfide equivalent weight is from 500 to 800 g/mol.

5. An organopolysiloxane comprising a co-hydrolytic condensation product of:
20 to 95 mol % of an organosilicon compound of general formula (4) below 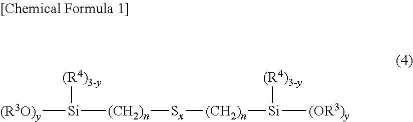
wherein n is an integer from 1 to 10, x is a statistical average value from 1 to 6, R³ is an alkyl group of 1 to 20 carbon atoms, an aryl group of 6 to 10 carbon atoms, an aralkyl group of 7 to 10 carbon atoms or an alkenyl group of 2 to 10 carbon atoms, R⁴ is an alkyl group of 1 to 10 carbon atoms or an aryl group of 6 to 10 carbon atoms, and y is an integer from 1 to 3;
5 to 80 mol % of an organosilicon compound of general foiinula (5) below 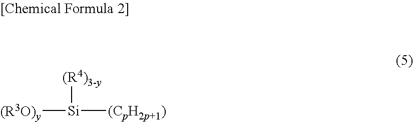
wherein R³, R⁴ and y are as defined above, and p is an integer from 5 to 10; and
0 to 10 mol % of an organosilicon compound of general formula (6) below 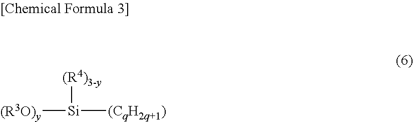
wherein R³, R⁴ and y are as defined above, and q is an integer from 1 to 4.

6. A rubber compounding ingredient comprising the organopolysiloxane of claim 1.

7. The rubber compounding ingredient of claim 6, further comprising at least one type of powder, wherein the weight ratio of the organopolysiloxane (A) to the at least one type of powder (B), expressed as (A)/(B), is from 70/30 to 5/95.

8. A rubber composition comprising the rubber compounding ingredient of claim 6 or 7.

9. A tire formed using the rubber composition of claim 8.
